(19) United States
(12) Patent Application Publication
(10) Pub. No.: US 2013/0188031 A1
(43) Pub. Date: Jul. 25, 2013

(54) RISK RECOGNITION METHOD FOR USE IN VIDEO SURVEILLANCE SYSTEM BASED ON HUMAN IDENTIFICATION

(71) Applicant: Electronics and Telecommunications Research In, Daejeon (KR)

(72) Inventors: So Hee PARK, Daejeon (KR); Jong-Gook KO, Daejeon (KR); Jin-Woo CHOI, Daejeon (KR); Jang-Hee YOO, Daejeon (KR)

(73) Assignee: Electronics and Telecommunications Research Institute, Daejeon (KR)

(21) Appl. No.: 13/684,090

(22) Filed: Nov. 21, 2012

(30) Foreign Application Priority Data
Jan. 19, 2012 (KR) 10-2012-0006391

(51) Int. Cl. H04N 7/00

(52) U.S. Cl. CPC H04N 7/002
USPC 348/77

(57) ABSTRACT

A risk recognition method based on human identification is disclosed, which identifies a human being from a captured image, such that it can recognize a dangerous situation of each person. The risk recognition method includes detecting a person from photographed image information, and identifying the detected person, thereby generating identification information for each person; extracting access control information for each person using the identification information; analyzing the access control information simultaneously while tracking a movement path for each person, and determining whether a dangerous situation for each person occurs; and if the dangerous situation occurs, selectively warning of the dangerous situation of the person who causes the dangerous situation.

### CROSS-REFERENCE TO RELATED APPLICATIONS

The present application claims priority to Korean patent application number 10-2012-0006391, filed on Jan. 19, 2012, which is incorporated by reference in its entirety.

### BACKGROUND OF THE INVENTION

The present invention relates to a risk recognition method based on human identification, and more particularly to a risk recognition method based on human identification, which identifies a human being from a captured image so as to recognize a dangerous situation of each person.

With the increasing development of information communication technology, a video intelligent system for realtime monitoring of a specific region at a remote site has been highlighted as an important matter of a surveillance or security system.

The video intelligent system serves as a security system, which acquires a video signal from at least one camera located in a target region to be monitored, compresses the video signal using a predetermined encoding scheme, transmits the compressed signal to a central control center located at a remote site over a communication network such as an Internet Protocol network, and allows the control center to decode the compressed video signal so as to monitor a current state of a target region to be monitored.

However, the conventional video intelligent system enables an administrator of the control center to visibly check/compare individual images so as to monitor a target region to be monitored. As a result, since the administrator of the control center has to continuously monitor the target region, concentration of the administrator is deteriorated as time goes by, resulting in reduction in the efficiency of security monitoring.

Therefore, the latest intelligent video surveillance system detects a human being from an input image, tracks the human being, and determines whether a current situation corresponds to a predetermined dangerous situation. If the predetermined dangerous situation is determined, the latest intelligent video surveillance system is designed to warn a user of the dangerous situation.

The above-mentioned intelligent video surveillance system is more automated and more intelligent than a human-based surveillance system, and recognizes a dangerous situation by tracking/analyzing a simple moving path of the detected human being. However, the intelligent video surveillance system has a disadvantage in that unexpected errors in warning of such dangerous situation are frequently generated.

The related art of the present invention has been disclosed in Korean Patent Laid-open Publication No. 10-2006-0031832 (published on Apr. 13, 2006), entitled “SMART VIDEO SURVEILLANCE SYSTEM BASED ON REALTIME BEHAVIOR ANALYSIS AND SITUATION RECOGNITION”.

### SUMMARY OF THE INVENTION

Various embodiments of the present invention are directed to providing a risk recognition method for use in a video surveillance system based on human identification that substantially obviates one or more problems due to limitations or disadvantages of the related art.

Embodiments of the present invention are directed to a risk recognition method for extracting access control information by identifying a human being from captured image information, tracking a moving path of the human being on the basis of the extracted access control information so as to determine whether a current situation is a dangerous situation, and generating a warning message for a human being who causes the dangerous situation.

In accordance with an embodiment, a risk recognition method based on human identification includes detecting a person from photographed image information, and identifying the detected person, thereby generating identification information for each person; extracting access control information for each person using the identification information; analyzing the access control information simultaneously while tracking a movement path for each person, and determining whether a dangerous situation for each person occurs; and if the dangerous situation occurs, selectively warning of the dangerous situation of the person who causes the dangerous situation.

The detecting and identifying of the person may further include identifying the person using radio frequency identification (RFID) information or electronic identification (ID) information.

The access control information may include at least one of a passage restriction time and a restricted zone for each person.

The determining of the dangerous situation may include at least one of determining whether a current time belongs to the restriction time, and determining whether a current position belongs to the restricted zone.

The identification information may include biological information.

The method may further include, if the dangerous situation occurs, transmitting identification information of the person who causes the dangerous situation and the image information to a management system.

### BRIEF DESCRIPTION OF THE DRAWINGS

FIG. 1 is a block diagram illustrating a risk recognition apparatus based on human identification according to one embodiment of the present invention.

FIG. 2 is a flowchart illustrating a risk recognition method based on human identification according to one embodiment of the present invention.

FIG. 3 is a conceptual diagram illustrating a human-being detection and recognition method according to one embodiment of the present invention.

FIG. 4 is a conceptual diagram illustrating an exemplary dangerous situation generated during tracking of a movement path.

### DESCRIPTION OF SPECIFIC EMBODIMENTS

Hereinafter, a risk recognition method based on human identification according to an embodiment of the present invention will be described in detail with reference to the accompanying drawings. In the drawings, line thicknesses or sizes of elements may be exaggerated for clarity and convenience. Also, the following terms are defined considering functions of the present invention, and may be differently defined according to intention of an operator or custom. Therefore, the terms should be defined based on overall contents of the specification.

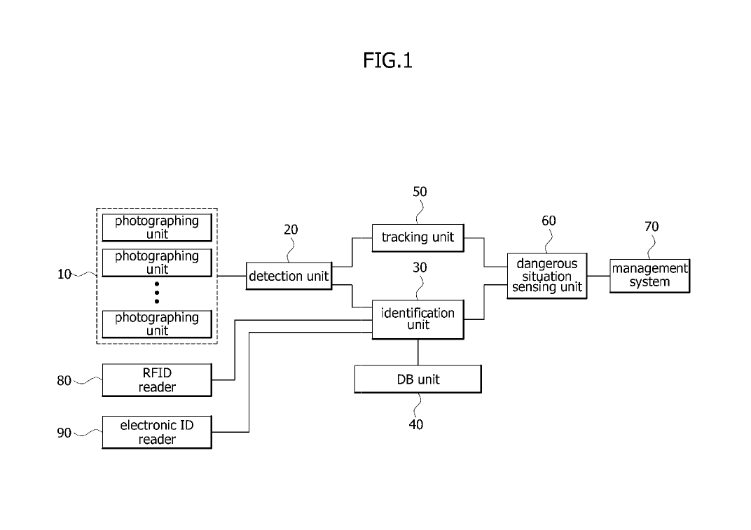

FIG. 1 is a block diagram illustrating a risk recognition apparatus based on human identification according to one embodiment of the present invention.

Referring to FIG. 1, the risk recognition apparatus based on human identification according to one embodiment of the present invention includes a photographing unit 10, a detection unit 20, an identification unit 30, a database (DB) unit 40, a tracking unit 50, a dangerous situation sensing unit 60, a management system 70, a radio frequency identification (RFID) reader 80, and an electronic ID reader 90.

The photographing unit 10 captures a predetermined photographing zone to be secured, generates image information, and transmits the generated image information to the detection unit 20. The photographing unit 10 is installed at each photographing zone. If necessary, a plurality of photographing units 10 may also be installed at each photographing zone.

The RFID reader 80 and the electronic ID reader 90 are installed in each zone to be secured, recognize an RFID card and electronic ID card carried by a human being who can go in and out of the zone, and transmit the recognized RFID information and electronic ID information to the identification unit 30.

The detection unit 20 analyzes image information captured by each photographing unit 10, detects a human being on the basis of the analyzed information, and transmits the detected information to the tracking unit 50 and the identification unit 30. In this case, the process for detecting a human being from the captured image can be readily implemented by those skilled in the art, and as such a detailed description thereof will be omitted herein for convenience of description and better understanding of the present invention.

The database (DB) unit 40 stores not only identification information for identifying each person, but also access control information assigned to each person.

The identification information includes biological information such as face, ear shape, gait information, etc. of each person, RFID information of each person, and personal information such as a name, address, post, etc. corresponding to either the biological information or the RFID information.

The access control information includes a passage restriction time and restricted-zone information assigned to each person.

The identification unit 30 compares detection information received from the detection unit 20 with identification information, extracts identification information of the detected person, extracts access control information of each person on the basis of the extracted identification information, and transmits the extracted result to the dangerous situation sensing unit 60.

In addition, upon receiving RFID information or electronic ID information from the RFID reader 80 or the electronic ID reader 90, the identification unit 30 may obtain identification information using the RFID information or the electrode ID information.

The tracking unit 50 tracks a movement path of each detected person using the detection information received from the detection unit 20, and transmits the tracked result to the dangerous situation sensing unit 60 in realtime.

The movement path may include personal position information for each time and zone on the condition that a person moves from a current position to another position.

The dangerous situation sensing unit 60 receives human identification information and associated access control information from the identification unit 30. Upon receiving a movement path from the tracking unit 50, the dangerous situation sensing unit 60 determines whether a current situation is a dangerous situation on the basis of the identification information, the access control information, and the movement path.

In accordance with the above-mentioned determination result, the dangerous situation sensing unit 60 may continuously track the movement path or transmit information of a dangerous situation through the management system 70. Specifically, if the occurrence of the dangerous situation is determined, information related to the corresponding dangerous situation is transmitted to the management system 70. For example, identification (ID) information of a person who causes a dangerous situation, image information acquired when the dangerous situation is photographed, etc. may be applied to the management system 70.

That is, the dangerous situation sensing unit 60 determines whether a current time belongs to a restricted time zone, or determines whether a current position belongs to a restricted zone, such that it can determine whether to apply the dangerous situation information to the management system 70.

For example, the dangerous situation sensing unit 60 tracks a movement path of a person on the basis of identification information, and at the same time determines whether the person exists in a restricted time zone or whether the current position corresponds to a restricted zone, such that it can determine whether to apply the dangerous situation information to the management system 70 on the basis of the determined information. In this case, if a specific time at which the person is photographed is within the restricted time zone, or if the position of the person is within the restricted zone, the occurrence of the dangerous situation is decided.

Specifically, the above-mentioned decision of the dangerous situation is independently performed for each person on the basis of identification information. Therefore, the dangerous situation sensing unit 60 discriminates between one person who has an authority to access a specific zone and the other person who has no authority to access the specific zone within the same image information. If a certain person who has no authority to access the specific zone approaches the restricted zone, the dangerous situation sensing unit 60 generates a warning message only for the approaching person, resulting in reduction in the number of erroneous warning messages.

Upon receiving dangerous situation information from the dangerous situation sensing unit 60, the management system 70 warns the administrator of the occurrence of the dangerous situation, outputs not only identification information of a person who generates the dangerous situation but also image information acquired when the dangerous situation is photographed to either an administrator terminal (not shown) or an alarm output device (not shown), such that the administrator can easily recognize the occurrence of the dangerous situation.

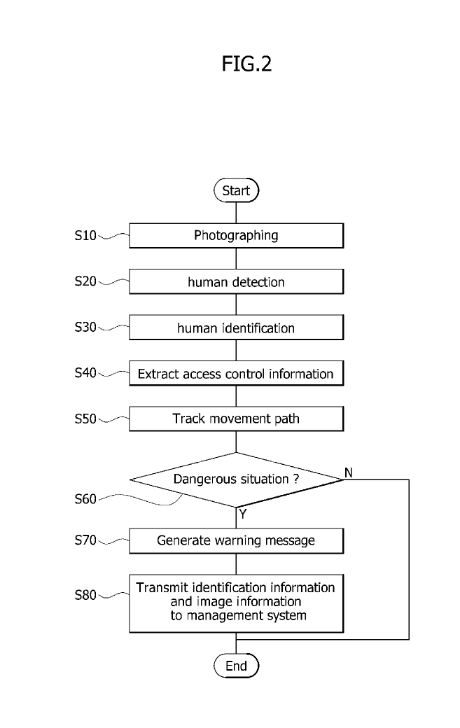

A risk recognition method based on human identification according to one embodiment of the present invention will hereinafter be described with reference to FIGS. 2 to 4.

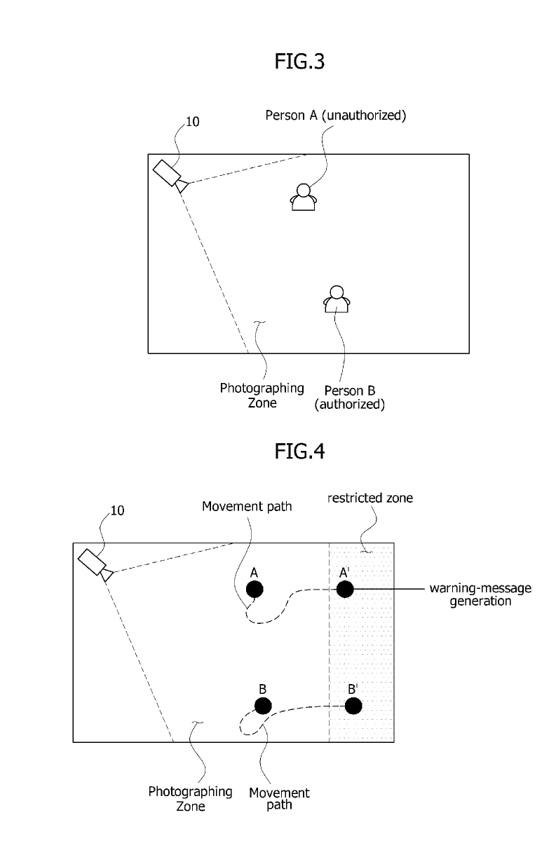

FIG. 2 is a flowchart illustrating a risk recognition method based on human identification according to one embodiment of the present invention. FIG. 3 is a conceptual diagram illustrating a human-being detection and recognition method according to one embodiment of the present invention. FIG. 4 is a conceptual diagram illustrating an exemplary dangerous situation generated during tracking of a movement path.

The photographing unit 10 captures a predetermined photographing zone so as to generate image information, and transmits the generated image information to the detection unit 20 (Step S10).

Upon receiving the image information from the photographing unit 10, the detection unit 20 detects a person from the received image information, and transmits the detection information to the tracking unit 50 and the identification unit 30 (Step S20).

Upon receiving the detection information from the detection unit 20, the identification unit 30 compares the received detection information with identification information of the database (DB) unit 40, extracts necessary identification information according to the result of comparison, and identifies a person corresponding to the extracted identification information (Step S30). The identification unit 30 extracts access restriction information of the corresponding person on the basis of the identification information (Step S40).

As described above, if the identification unit 30 extracts identification information and access restriction information, it transmits the extracted information to the dangerous situation sensing unit 60.

Meanwhile, if the RFID reader 80 acquires RFID information, it transmits the RFID information to the identification unit 30. The identification unit 30 extracts identification information using the RFID information, such that it can also perform human identification in the same manner as in the aforementioned image-based human recognition scheme.

Upon receiving detection information from the detection unit 20, the tracking unit 50 tracks a movement path of the same person using the received detection information, and transmits the tracked result to the dangerous situation sensing unit 60 in realtime (Step S50).

The dangerous situation sensing unit 60 receives human identification information and associated access control information from the identification unit 30, and receives a movement path from the tracking unit 50, such that it determines whether a dangerous situation for each person has occurred using the received identification information, the access control information, and the movement path (Step S60).

That is, it is determined whether a time for each person belongs to a restricted time zone, and it is also determined whether a current position belongs to a restricted zone, such that the dangerous situation sensing unit 60 can determine whether to apply the dangerous situation information to the management system 70.

If a current situation is not determined to be the dangerous situation, the dangerous situation sensing unit 60 controls the tracking unit 50 to continuously track the movement path of the corresponding person.

Otherwise, if the dangerous situation has occurred, the dangerous situation sensing unit 60 transmits information of the dangerous situation to the management system 70, and the management system 70 selectively generates a warning message only of a person who causes the dangerous situation (Step S70).

In addition, the dangerous situation sensing unit 60 transmits not only identification information of the person who causes the dangerous situation, but also image information of the captured dangerous situation to the management system 70 (Step S80).

Therefore, the management system 70 may transmit identification information of the person who causes the dangerous situation and the image information of the captured dangerous situation to either the administrator terminal or the alarm output device (not shown), such that the administrator can easily recognize the occurrence of the dangerous situation.

In this case, the administrator can take a variety of measures against the dangerous situation. For example, the administrator gains access to the management system 70 such that he or she may further obtain a variety of detailed information of the dangerous situation or may apply the obtained information to other administrators as necessary. If necessary, the administrator may also search for a certain person using image information of the person who causes the dangerous situation, and a detailed description thereof will hereinafter be described with reference to FIGS. 3 and 4.

Referring to FIG. 3, the photographing unit 10 captures a person A and a person B within a photographing zone. Under the condition that the person A and the person B are identified, if the person A moves from one position A to another position A′ and the person B moves from one position B to another position A′, the person A is located at an unauthorized zone, such that a warning message only for the person A is generated through the management system 70.

However, since the position B′ of the person B is determined to be an authorized zone, there occurs no warning message for the person B.

In more detail, the risk recognition method based on human identification according to one embodiment of the present invention acquires identification information for each person, extracts access restriction information for each person on the basis of the acquired identification information, determines the presence or absence of a dangerous situation for each person on the basis of the acquired identification and the extracted access restriction information, and generates a warning message only of a person who causes the dangerous situation, resulting in reduction in the number of erroneous warning messages.

As is apparent from the above description, the risk recognition method according to the present invention detects a human being from the captured image information, identifies the detected human being, detects the presence or absence of a dangerous situation of each human being on the basis of the identified information, and reduces the number of erroneous warning messages, thereby providing an efficient security service.

In addition, if a dangerous situation occurs by a certain human being, the risk recognition method according to the present invention transmits not only identification information but also image information obtained when the dangerous situation is photographed to a management system, and allows an administrator of the management system to easily recognize the occurrence of such dangerous situation. As a result, the administrator can directly check a human being who causes the dangerous situation, thereby providing more efficient security services.

While the present invention has been described with respect to the specific embodiments, it will be apparent to those skilled in the art that various changes and modifications may be made without departing from the spirit and scope of the invention as defined in the following claims.

What is claimed is:

1. A risk recognition method based on human identification comprising:
detecting a person from photographed image information, and identifying the detected person, thereby generating identification information for each person;
extracting access control information for each person using the identification information;
analyzing the access control information simultaneously while tracking a movement path for each person, and determining whether a dangerous situation for each person occurs; and
if the dangerous situation occurs, selectively warning of the dangerous situation of the person who causes the dangerous situation.

2. The method according to claim 1, wherein the detecting and identifying of the person further includes:
identifying the person using radio frequency identification (RFID) information or electronic identification (ID) information.

3. The method according to claim 1, wherein the access control information includes at least one of a passage restriction time and a restricted zone for each person.

4. The method according to claim 3, wherein the determining of the dangerous situation includes at least one of determining whether a current time belongs to the restriction time, and determining whether a current position belongs to the restricted zone.

5. The method according to claim 1, wherein the identification information includes biological information.

6. The method according to claim 1, further comprising:
if the dangerous situation occurs, transmitting identification information of the person who causes the dangerous situation and the image information to a management system.
